(19) United States
(12) Patent Application Publication
(10) Pub. No.: US 2022/0341738 A1
(43) Pub. Date: Oct. 27, 2022

(54) System and Method for Navigating Over Water

(71) Applicant: TRIANGULATE LABS, LLC, Cincinnati, OH (US)

(72) Inventor: William D. HALL, Cincinnati, OH (US)

(21) Appl. No.: 17/606,350

(22) PCT Filed: Apr. 23, 2020
(86) PCT No.: PCT/US2020/029504

§ 371 Date: Oct. 25, 2021

Related U.S. Application Data
(60) Provisional application No. 62/838,662, filed on Apr. 25, 2019.

(51) Int. Cl. G01C 21/16; G01C 21/00; G06T 7/55

(52) U.S. Cl. CPC G01C 21/1656; G01C 21/005; G06T 7/55

(57) ABSTRACT

A system that measures the motion of a platform traveling over water by reference to images taken from the platform. In one embodiment, the invention is comprised of a computer connected to a camera and an Inertial Measurement Unit (IMU) which provides estimates of the platform's location, attitude and velocity by integrating the motion of the platform with respect to features on the water's surface, corrected for the motion of those features. The invention measures the motion of the water features according to equations of surface water wave celerity to measure motion of features across the water, and by measuring the feature motion shear across images or the discrepancy between the navigation estimates and the observed water feature motion to detect boundaries of water currents. The invention is also capable of measuring water depth, wave motion, sea state and current present in the water, whether affixed to a navigating platform or to a stationary reference point.

### TECHNICAL FIELD

The present invention pertains to navigational systems and methods. Specifically, the invention permits navigation of a platform over water by reference to images collected from the platform.

### BACKGROUND

The Global Positioning System (GPS) and similar satellite-based area navigation (RNAV) systems provide a navigational reference over water by timing radio frequency wave transmission from satellites. Numerous other approaches to RNAV capability have been developed using ground-based transmitters. Such systems require man-made components be deployed in the environment external to the navigating platform.

High-end inertial navigation systems (INSs) can provide capability similar to GPS for limited endurance flights based only on components onboard the platform. The costs of such systems increase drastically with the length of the flight. Augmented INSs, in which the drift experienced due to biases in the INS is removed and the biases themselves are calibrated, can be very cost effective and can outperform the accuracy of the navigation reference used to augment them. For instance, a common method of GPS-based INS augmentation can provide a navigation reference accurate to the centimeter or better, as the navigation system is able to remove the random walk exhibited in GPS even as it uses the GPS measurements to limit the INS drift.

Vision-based INS augmentation, which is often referred to as Visual-Inertial Odometry (VIO), has proven to be effective in many situations lacking GPS. Current vision-based systems rely on recognition of landmarks and/or on the visual measurement of speed past features on the ground, a powerful technique in that it is independent of any equipment external to the platform. Many of these techniques identify features using feature detectors that produce a consistent label when viewing the same feature from different vantage points and scales. Given consistently labeled features from multiple views, the camera pose (three dimensions of position and three of angular orientation) and locations of features in 3D are found through linear algebra and least-squares optimization. The Scale-Invariant Feature Transform (SIFT), Speeded-Up Robust Features (SURF) and related feature detectors are widely recognized for their ability to work reliably over static 3D scenes. They have become the cornerstone of many vision-based navigation techniques.

The following papers describe VIO systems:

[1] T. Lupton, S. Sukkarieh, “visual—inertial-aided navigation for high-dynamic motion in built environments without initial conditions”, IEEE Trans. Robot., vol. 28, no. 1, pp. 61-76, February 2012.

[2] C. Forster, L. Carlone, F. Dellaert and D. Scaramuzza, “On-Manifold Preintegration for Real-Time Visual—Inertial Odometry,” in IEEE Transactions on Robotics, vol. 33, no. 1, pp. 1-21, February 2017. doi: 10.1109/TRO.2016.2597321

[3] T. Qin, P. Li and S. Shen, “VINS-Mono: A Robust and Versatile Monocular Visual-Inertial State Estimator,” in IEEE Transactions on Robotics, vol. 34, no. 4, pp. 1004-1020, August 2018.

doi: 10.1109/TRO.2018.2853729

[4] Delmerico, Jeffrey A. and Davide Scaramuzza. “A Benchmark Comparison of Monocular Visual-Inertial Odometry Algorithms for Flying Robots.” 2018 IEEE International Conference on Robotics and Automation (ICRA) (2018): 2502-2509.

### SUMMARY OF THE INVENTION

The invention provides a system that measures the motion of a platform traveling over water by reference to images taken from the platform. In one embodiment, the invention comprises a computer connected to a camera and an Inertial Measurement Unit (IMU), and which provides estimates of the platform's location, attitude and velocity by integrating the motion of the platform with respect to features on the water's surface, corrected for the motion of those features. In addition to providing a navigation reference, the invention is capable of measuring water depth, wave motion, sea state and current present in the water.

### BRIEF DESCRIPTION OF THE DRAWINGS

The accompanying drawings, which are incorporated in and constitute a part of this specification, illustrate embodiments of the invention and together with the detailed description given below, serve to explain various aspects of the invention.

FIG. 1 shows the system diagram of a typical embodiment of a system incorporating the invention.

FIG. 2 shows the flowchart of a VRU which computes a navigation reference from video taken from the navigating platform, calculating the relationship between the vehicle and the waterborne features seen in the video feed, calculating the motion of those waterborne features, and computing the vehicle's estimated motion relative to a fixed reference frame.

FIG. 3 shows features tracked in forward flight (top) and while transitioning from turning flight (bottom).

FIG. 4 depicts how the water's surface can be represented as an additive combination of sinusoidal waves.

FIG. 5 shows a water surface image on the left and its Fourier transform magnitude-spectrum plot on the right.

FIG. 6 shows the low-frequency wave images resulting from a bandpass operation.

FIG. 7 shows a frame from sample downward-looking video with short wavelength (white) and long wavelength (green) feature tracks as computed by our implementation superimposed.

FIG. 8 shows the averaged Fourier analysis of the down-looking video collected.

FIG. 9 illustrates the quantities required to calculate the sign of wave speed correction from a vector difference.

FIG. 10 illustrates how open ocean currents such as the Gulf Stream are typically relatively narrow and fast-moving.

FIG. 11 shows the phase change over one second in collected down-looking wave video taken from a stationary position.

FIG. 12 shows the color scale used in FIGS. 11 and 13.

FIG. 13 shows the phase change over one second in collected down-looking wave video taken from a second position offset by 2.5 m from the first position.

FIG. 14 shows a flowchart of the calculation of the phase shift cost function.

### DETAILED DESCRIPTION

The subject invention permits over-water navigation through integration of the wave propagation characteristics into navigation calculations. Two complementary approaches are taken and have been demonstrated from collected test data: 1) a feature-tracking approach including feature velocity estimation and correction; and, 2) a frequency-domain wave carrier phase tracking approach. The feature-tracking approach is described followed by the frequency-domain approach. Each approach includes measures of its estimate quality. In one embodiment both methods are used and their estimates are combined based on the produced measures of estimate quality.

### Feature Tracking Over Water

The Scale-Invariant Feature Transform (SIFT), Speeded-Up Robust Features (SURF) and related feature detectors are widely recognized for their ability to work reliably over static 3D scenes. They have become the cornerstone of many vision-based navigation techniques. While these methods work well with visual targets that are static in appearance, they fail to produce consistent descriptors when applied to images of the water's surface, leading to failure of the methods relying on them. Furthermore, while these feature detectors attempt to produce the same features at multiple scales, the subject invention benefits from scale-variant feature detection. That is, the recognition of features only at a specific scale is part of what permits the invention to recognize and track waves of specific wavelengths. Because the wavelength of a wave is proportional to the square of its speed along the surface of the water (see [5], [6]), the invention can compensate for the motion of the tracked water features. This effectively produces features that are nearly stationary in the water by removing the motion of the waves. The motion of the water itself in the form of currents can also be removed through detection of the change in the water's velocity compared to fixed or waterborne features outside of the current.

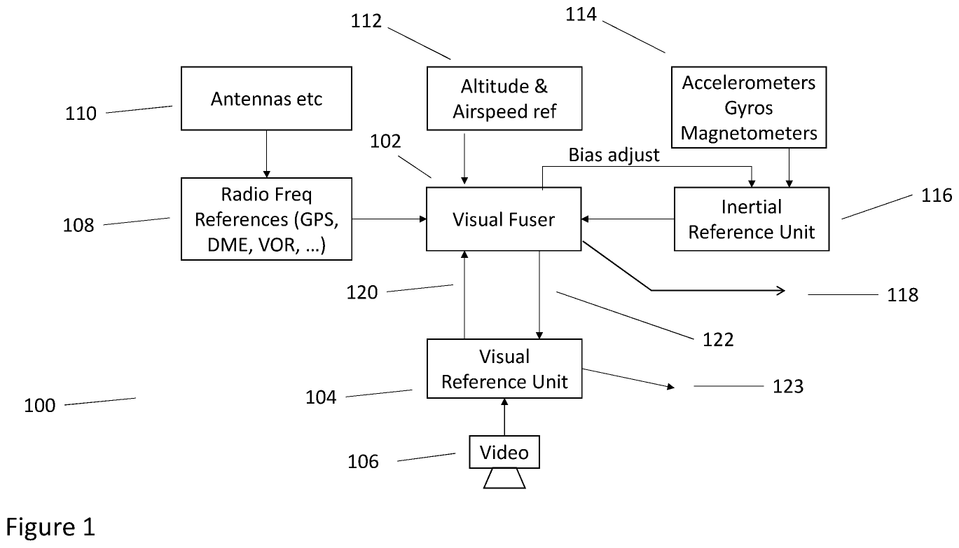

Referring to FIG. 1, one embodiment of the system 100 is comprised of a Visual Reference Unit (VRU) 104 and Visual Fuser (VF) 102. The VRU provides velocity measurements 120 based on one or more vision sensors 106. The velocity measurements 120 are used within the VF 102, a modification of a more traditional navigation fusion algorithm that incorporates vision as well as other updates. The VF 102 estimates and updates inertial biases, and it provides feed-forward messages 122 to the VRU 104 to assist in feature tracking. In addition to producing a navigation estimate 118, the VF produces environment measurements 123. These include the locations and status of objects, the sea state, winds, and so forth.

The VF 102 should also accept input from other optional navigation reference systems as shown in FIG. 1, including Radio Frequency (RF) systems 108, altitude and airspeed references 112, and inertial references from an Inertial Reference Unit (IRU) or Inertial Measurement Unit (IMU) 116. Standard techniques from the prior art for incorporating such references, such as Kalman filters, extended Kalman filters, and bundle adjustment optimization as used in some VIO systems are appropriate for the VF.

When the VF is based on bundle adjustment optimization, the optimization problem can be formulated with residual blocks corresponding to each type of sensed input that the VF is fusing. The decision variables for the VF to determine include the location and attitude of the vehicle at each point in time, the 3D locations of the feature references tracked by the VRU, bias terms for the gyros and accelerometers, average wave velocity for each wavelength tracked, wind velocity, lens focal length and distortion coefficients, barometric pressure, and elevation of the body of water being overflown. If the VF begins operations while an absolute positioning system like GPS is working, and subsequently the absolute positioning system ceases to work, the VF can lock decision variables that are poorly determined without the absolute positioning system. For instance, without a GPS source, variables concerning the water elevation, barometric pressure and lens characteristics should be locked.

Within a VF based on bundle adjustment, it is desirable for the objective weights on the residual blocks to be adjusted to ensure that more accurate measurements are weighted higher than less accurate measurements. Some GPS sources can report their accuracy dynamically as it is affected by factors such as the geometry of the satellites or consistency of the navigation solution in the receiver. Such information can be used by the VF to adjust the weight given in the solution to the GPS position measurements.

The VF based on bundle adjustment also benefits from a model of the motion characteristics of the vehicle. Fixed-wing aircraft move through the air along the flight path vector. The flight path vector differs from the direction the aircraft is pointed by the angle of attack and the slip angle. The acceleration of the aircraft as it moves along its trajectory is governed by the forces applied to its mass by Newton's laws. The forces applied to the aircraft in a steady-state atmosphere without significant lift or sink are due to the power applied by the engines minus the power used by the aircraft's climb rate and by aerodynamic drag. Similarly, changes in orientation are governed by the aircraft's moment of inertia and the moments applied to it by changing weights and control surfaces. These relationships can be expressed within the bundle adjustment optimization by adding decision variables for the control and environmental inputs—engine power, air mass lift, angle of attack, slip angle and control surface moments—and by adding residual blocks enforcing Newton's laws.

With bundle adjustment so configured, the optimization finds solutions that respect the laws of motion. This can be useful in avoiding large sudden changes in positions or orientations that could otherwise be caused by noisy sensor measurements or mis-correspondences between feature points observed in camera images from different positions.

In order to estimate accurately the motion of the features across water, the VRU 104 must be capable of robustly tracking waves and features of multiple wavelengths and measuring those wavelengths. The VRU creates a water-relative reference by subtracting out wave motion. It does so by leveraging the different propagation characteristics of different wavelengths of waves.

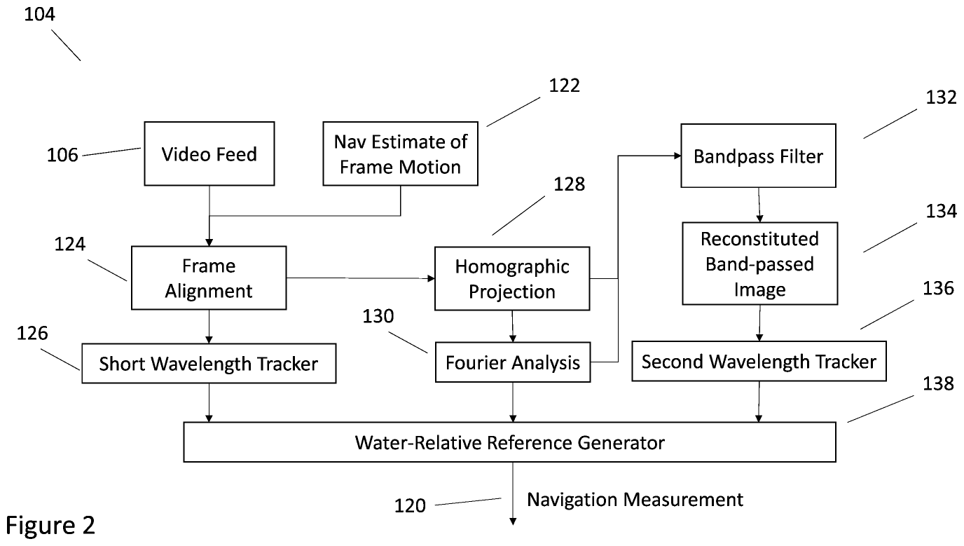

Referring to FIG. 2, the VRU 104 computes navigation measurements 120 to send to the VF. The video feed 106 represents the camera input to the VRU. The Navigation Estimate 122 provides a feed-forward tracking input from the navigation solution to the VRU. This feed forward signal allows the Frame Alignment module 124 to produce an initial alignment of the previous and current video frame. The Frame Alignment module applies the estimated attitude and position rates, integrated backward in time by the time interval between images, to align and project the previous video frame onto the new video frame. This initial alignment improves feature tracking performance in high optical flow scenarios such as high-altitude maneuvering flight combined with narrow field of view optics. Frame alignment is not strictly necessary in stable flight using wide angle optics.

The Short Wavelength Tracker 126 uses the highest resolution imagery available from the sensors to track features from frame to frame. We have found that Shi-Tomasi corner detection and pyramidal Lucas-Kanade tracking are effective within the Short Wavelength Tracker 126, capable of locking on to numerous water features for several minutes in many conditions. Occasionally, Lucas-Kanade tracking can track a feature in one image to an incorrect point in the next image. We detect this situation by also running the Lucas-Kanade algorithm backwards from the new frame to the previous frame. This reliably recovers the original point when the tracking worked well and fails to find the original point from the incorrect points. When the original point is not found, our implementation drops the feature. Similarly, the Lucas-Kanade tracker calculates a quality measure, and when this quality degrades due to changes in the shape of the feature or its occlusion, our implementation drops the feature. When an insufficient number of features remains, our implementation again uses Shi-Tomasi detection to replace find additional ones. In this way, a full set of features is tracked, and optical flow is measured across the full image without interruption. In our experience, the water features persist for enough frames to allow for high quality motion measurements at 30 frames per second (FPS). Slightly different motion of different features can be averaged to obtain a consistent and accurate measurement of the velocity of the water features directly, or if wave velocity decision variables are included in the bundle adjustment optimization it solves for the wave velocity.

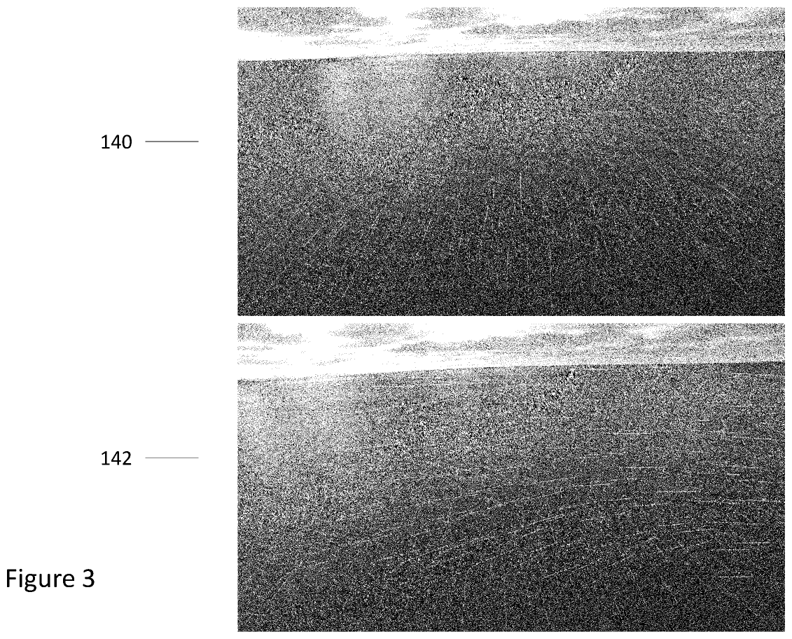

The Short Wavelength Tracker 126 in FIG. 2 tracks the smallest detected features at the highest resolution from the aligned frames. The output of the Short Wavelength Tracker is sent to the Water-Relative Reference Generator 138. Sample output of the Short Wavelength Tracker can be seen in FIG. 3. The top image 140 shows feature tracks generated by our initial implementation of the short wavelength feature tracker during a forward flight segment. The flight was at approximately 35 MPH at an altitude of 390 feet above water. Similar optical flow would be realized at 300 knots at 4000 feet or 600 knots at 8000 feet with a comparable wide-angle camera. The white tracks on the image reveal the location of the short wavelength features in the images over a two second sequence at 30 frames per second. Our implemented tracker is robust in these conditions. The bottom image 142 is another instance showing accurate feature tracking during a portion of the flight including a rapid turn.

Referring again to FIG. 2, in parallel to the short wavelength tracking process, the same image feed is transformed via homographic projection 128 such that the transformed image has consistent scale per pixel across the image. For example, if one pixel represents one foot at the corner of the image, it represents one foot at the center and at the other corners as well. In the case of downward-looking images, this transformation may be able to use the full image. In the case of forward-looking images that include the horizon, the homographic projection is performed on only that portion of the input image containing sufficient resolution per meter on the surface. This transformation produces a projected image such that in-image distances are proportional to distances along the water's surface. A Fourier transform 130 on the projected image provides information about the spectral properties of the waves and is sent to the Water-Relative Reference Generator 138, allowing the algorithm to track specific longer wavelength waves.

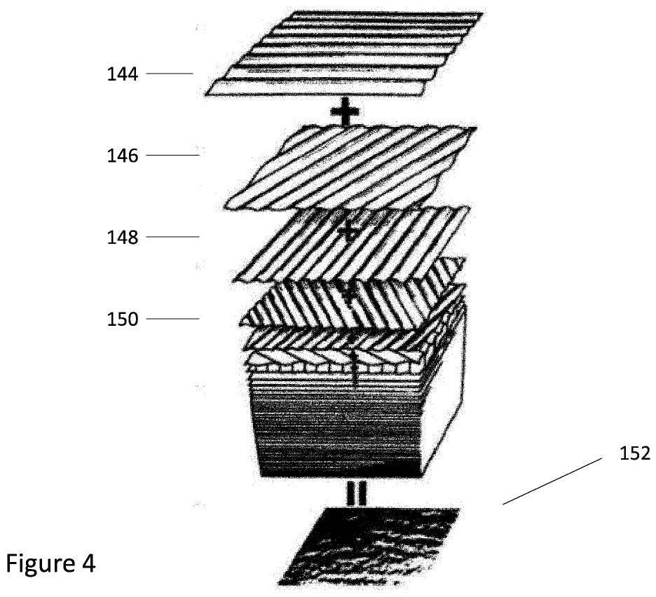

FIG. 4 illustrates the importance of different wave frequencies. It is useful to think of the water's surface 152 as the superposition of different wave frequencies 144 146 148 150. The speed traveled by a wave of a single wavelength, or more accurately the celerity of the wave, is well modeled as proportional to the square root of the wavelength in deep water¹. Thus, longer ocean swells overtake shorter wind-driven waves, which themselves travel much faster than the foam caused when waves break or from the wind ripples of a gust. These different types of waves may originate from different sources as well, traveling in different directions. Taken together, the form of the water's surface changes rapidly in ways that can confound a feature detector. However, the fact that the speeds are a function of measurable characteristics of the water feature—swell, wave, ripple, foam, etc.—provides a key to measuring the motion of the water itself. This fact may be used to compensate for the features' motions. ¹ For depth d greater than ½ the wavelength L, the celerity of waves is well modeled by

$$\sqrt{\frac{gL}{2 π}} ,$$

where g is the local gravitational acceleration of approximately 9.8 m/s². Thus, c≈1.25 √L, depending on local gravity. [6]

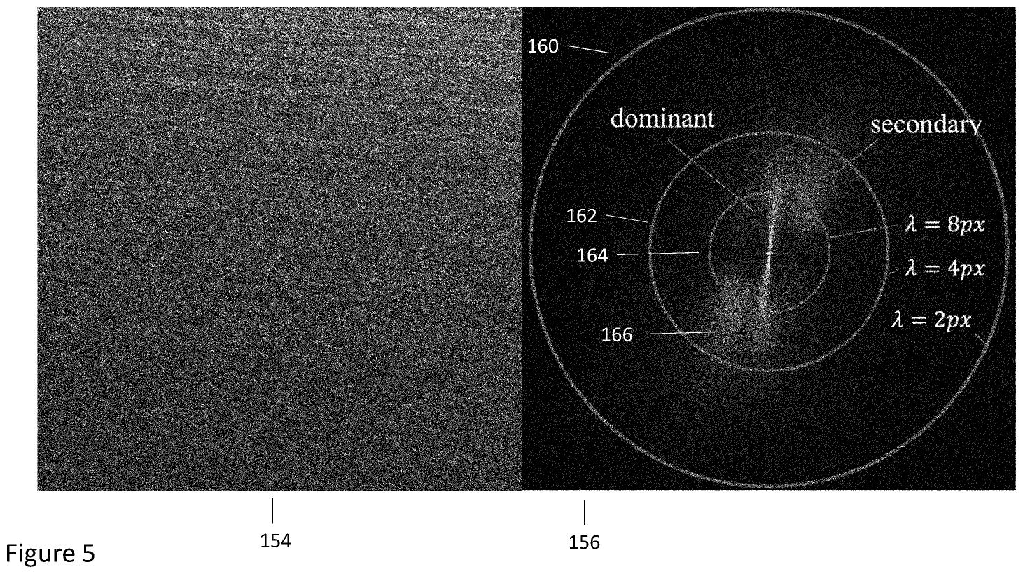

FIG. 5 shows an image of the water surface 154 and its Fourier transform 156. The Fourier transform breaks apart the composite image into its frequency components, effectively recovering the layers shown in FIG. 4. In the Fourier magnitude-spectrum plot of FIG. 5 156, (0,0) is at the image center. The plot itself is white on a black background, with narrow white guide circles 160 162 164 superimposed at maximum frequency (2 pixel wavelength outer circle 160, equating to approximately 6″ wavelength at this altitude and distance), half that frequency (4 pixel wavelength middle guide circle 162, about 1′ wavelength), and half again for the inner circle 164. The intensity of each point (x,y) 166 on the magnitude spectrum plot corresponds to the magnitude of the contribution of a wave with horizontal frequency component x and vertical frequency component y.

The dominant directional component of the waves coming toward the viewer in the left side of FIG. 5 154 are apparent in the frequency domain in the right side 156, especially near the origin. The dominant wave pattern corresponds to the bright line through the origin which would pass through 12:30 and 6:30 positions on a clock face. The dominant direction includes very low frequencies corresponding to about a 4-pixel (1′) wavelength. Note that the frequencies relate to the image intensity rather than wave height, so the fact that the image 154 is brighter at the top than the bottom is represented by extremely low-frequency components of the transform 156.

The patterns farther from the origin represent higher frequency waves and features. In the image 154 one can see a short wind-driven wave moving from the bottom-left of the image. Its corresponding spectrum is represented by the cloud labeled “secondary” on the magnitude-spectrum plot 156. The spread around the 8:00 and 2:00 positions corresponds to these superimposed higher frequency waves. Note that the wavelength of the wind-driven wave is about 8 pixels, or 2′, as it is centered at about the distance of the inner blue guide circle 164 from the origin.

Referring again to FIG. 2, the frequency analysis of the entire image, which is performed in the Fourier Analysis module 130, identifies the primary frequencies and wavelengths of the waves in the water surface. From this information the invention calculates the speed of the waves in the image according to the wave propagation equations (For depth d greater than the wavelength L, the celerity of waves is well modeled by

$$\sqrt{\frac{gL}{2 π}} ,$$

where g is the local gravitational acceleration of approximately 9.8 m/s². Thus, c≈1.25 √L, depending on local gravity. For shallower waters, the relation is more complex and can be used to calculate water depth (see [6]). The same technique will determine the speed and direction, except for a sign ambiguity, of the wave associated with each feature that the Shi-Tomasi corner detector finds.

The Fourier transformed image 130 from the Fourier Analysis module is passed through a bandpass filter 132 such as a Butterworth filter. An inverse Fourier transform is then applied to the output of the bandpass filter to reconstitute a bandpass-filtered image 134. The Second-Wavelength Tracker 136 then applies Shi-Tomasi corner detection and pyramidal Lucas-Kanade tracking to track the longer-wavelength waves, and the result is sent to the Water-Relative Reference Generator 138.

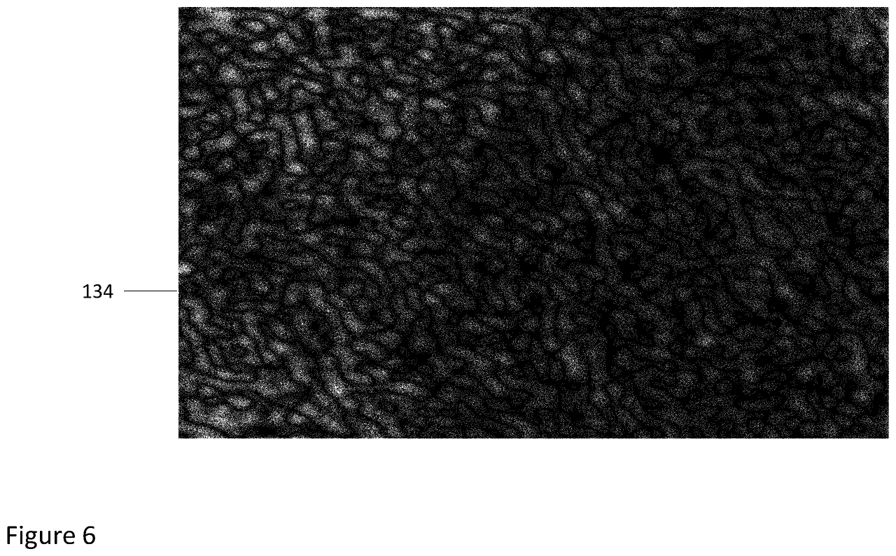

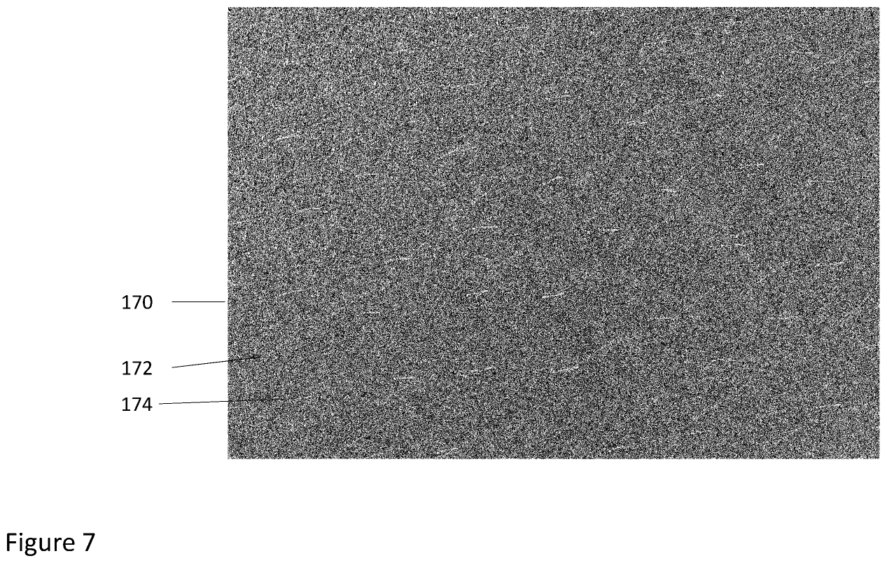

FIG. 6 shows a sample image 134 of the reconstituted bandpass-filtered image, in which longer wavelength waves can be seen. FIG. 7 shows the resulting short-wavelength tracks 174 in white and longer second-wavelength tracks 172 in gray, superimposed on one image frame 170 of the water video from which they were generated. This video was captured from a stationary vantage point 390 feet up with the top of the image toward the west. The length of each feature track is proportional to the feature's speed (it shows its travel over the previous second). The camera was stationary during video capture to the best of the abilities of the drone that collected the video, so the motion tracked is due almost entirely to feature motion across the water's surface. The long wavelength features averaged 6.02 knots in a 150° direction, whereas the short wavelength features traveled at 1.53 knots in a 180° direction, over the 3 minutes spent on station recording this video.

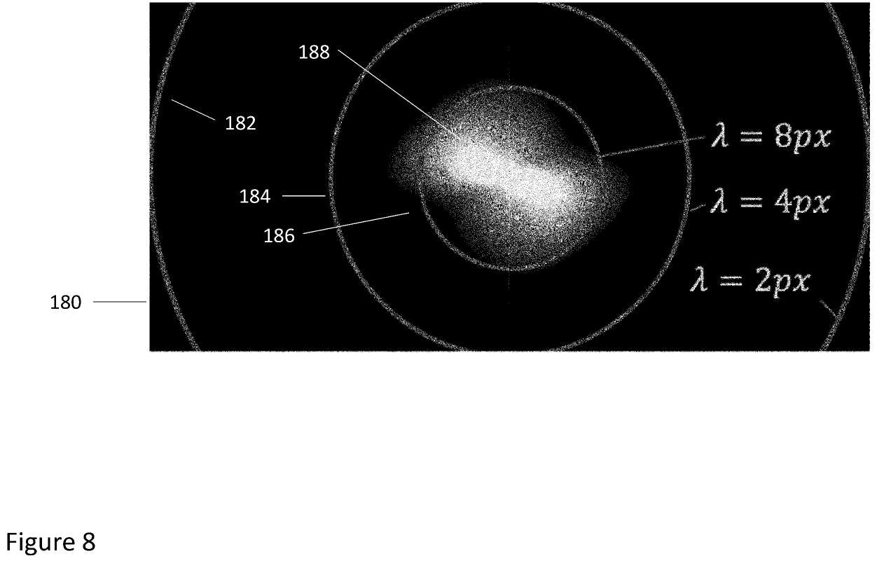

These measured feature speeds fit well with the wave frequencies measured in space using the Fourier transform and the predictions of surface wave celerity. The feature tracker works best on the highest frequency parts of the image that move consistently together. Referring to FIG. 8, the averaged magnitude spectrum plot 180 shows the frequencies consistently present in the video. The highest frequency of notable spectral power in the video shows up at a wavelength of 8 pixels 186 in our Fourier plot 180, corresponding to a wavelength of 0.4 m. Applying the deep-water celerity approximation, these features should travel at 1.55 knots. Similarly, the low-frequency tracker works with a bandpass that admits wavelengths down to 124 pixels long (but no shorter). The celerity calculated from 124-pixel long waves is 6.08 knots, again quite close to the feature motion observed from optical flow.

The Water-Relative Reference Generator 138 in FIG. 2 calculates the direction of feature flow up to 180° ambiguity from the Fourier magnitude spectrum plot by finding the power-weighted average direction at the radius corresponding to the wavelength being tracked. In our sample down-looking video spectrum 180 of FIG. 8, this produces a direction of 193° for the short-wavelength waves (vs 180° measured by flow) and 167° for the long-wavelength waves (vs 150° measured by flow). The next section describes how the Water-Relative Reference Generator 138 resolves the sign ambiguity.

### Water-Relative Reference Generator Algorithm

In FIG. 2, the output of the trackers 126 and 136 and the wave spectrum Fourier analysis 130 described above serve as input to the Water-Relative Reference Generator 138 algorithm. The reference generator 138 uses the water-specific features of multiple wavelengths to resolve points of reference stationary with respect to the water. That is, it corrects for the motion of the features along the surface to generate a stationary reference. If currents are present, the stationary reference will move with the current. However, the current motion can be removed as well, as described in Section 2.2.

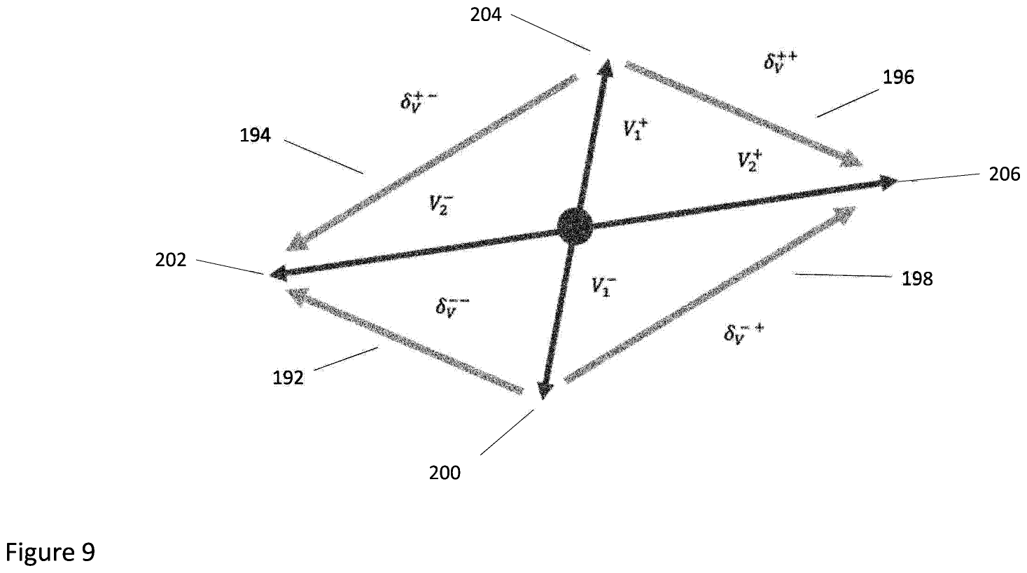

The reference generator 138 resolves the sign ambiguity by examining the speeds and directions of multiple wavelength features. Referring to FIG. 9, the velocity of the short frequency waves is known up to the sign ambiguity, thus it could be one of two values which we denote V₁⁺ 204 or V₁⁻ 200. Similarly, the secondary frequency waves could have velocity V₂⁺ 206 or V₂⁻ 202. The difference between the velocity of the different wave types as measured by optical flow, δ_{V}=V₂−V₁, should thus take on one of four values (two values for the short wavelength's sign times two values for the long wavelength's sign). We denote these values δ_{V}⁻⁻ 192, δ_{V}⁻⁺ 198, δ_{V}⁺⁻ 194, and δ_{V}⁺⁺ 196. The reference generator uses the value of the signs that minimizes the discrepancy between the velocity measured by optical flow, δ_{V} and the options δ_{V}⁻⁻ 192, δ_{V}⁻ 198, δ_{V}⁺⁻ 194, and δ_{V}⁺⁺ 196 predicted according to the frequency spectrum-predicted celerity. Note that this method works independent of errors in the initial vehicle motion estimate, as long as the system can measure the difference δ_{V}=V₂−V₁. If an error in vehicle motion estimate leads to an error V_{ϵ} in both V₁ and V₂, such that \hat{V}₁=V₁+V_{ϵ} and \hat{V}₂=V₂+V_{ϵ}, the error will cancel out in the calculation of δ_{V}. With the sign of the wave feature velocities resolved, the system generates pseudo-reference points tied to features but corrected for the estimated feature velocities. It uses those pseudo-reference points within the prior art techniques employed in VIO to measure vehicle motion, which it outputs.

To carry the example forward with the data derived from the video, the optical flow vector of 1.53 knots at 180°, minus the spectrum-estimated vector of 1.55 knots at 193° yields a reference motion of 0.35 knot at 267° relative to the vehicle. This equates to a motion of 105 feet over the three-minute video.

### Current Adjustment

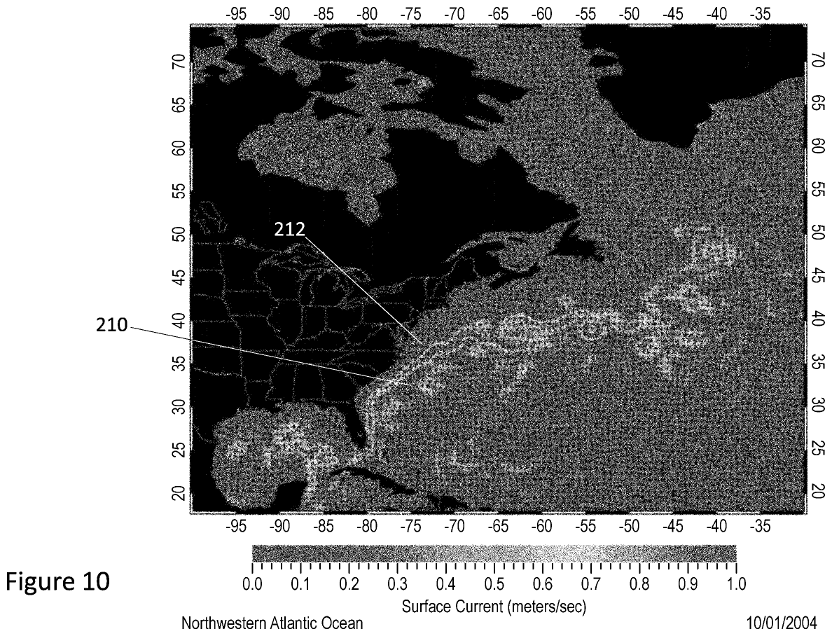

Currents in the open oceans are typically relatively narrow and concentrated (see [7]). For example, see FIG. 10, which shows the surface water velocity in the Caribbean and Atlantic oceans associated with the Gulf Stream 212. Currents can be detected by the invention by recognizing the speed differential of the water at the navigating platform's crossing of the current boundary. If the navigating platform crosses the current boundary at sufficient altitude that both sides of the shear zone are in the field of view simultaneously, it is possible to measure the current differential directly. In many cases, the current shear may be detected from the water speed sensing techniques discussed above, by recognizing different speeds of the water in different parts of the image. For more subtle current transitions in installations with a reasonably good IMU, a rapid change in the discrepancy between the water estimates and the inertial speed estimates may indicate currents. It may be desirable to cue current detection with an infrared sensor, since the sea surface temperature gradient across the current boundary is typically high. As with most aspects of navigation sensors, better and more expensive sensors enable operation with higher accuracy under a wider range of conditions.

### Frequency-Domain Measurement of Over-Water Velocity

The embodiment described above provides one means of estimating feature motion over water so that it can be removed. This embodiment relies on a limited subset of the frequency information available in the images may prove limiting in certain conditions. The following embodiment provides an alternative means of utilizing more information from the images. It is expected that it could replace or augment the rightmost column of the VRU block diagram of FIG. 2 or could indeed be used to replace the entire VRU.

Given the series of orthonormal images of the water's surface that are the input to that rightmost column of the VRU block diagram, the Frequency-Domain based calculation uses pairs of images separated by a consistent amount of time dt, e.g., 1 second. The images are first adjusted so that they are effectively from the same vantage point, altitude and attitude according to the navigation system estimates fed forward.

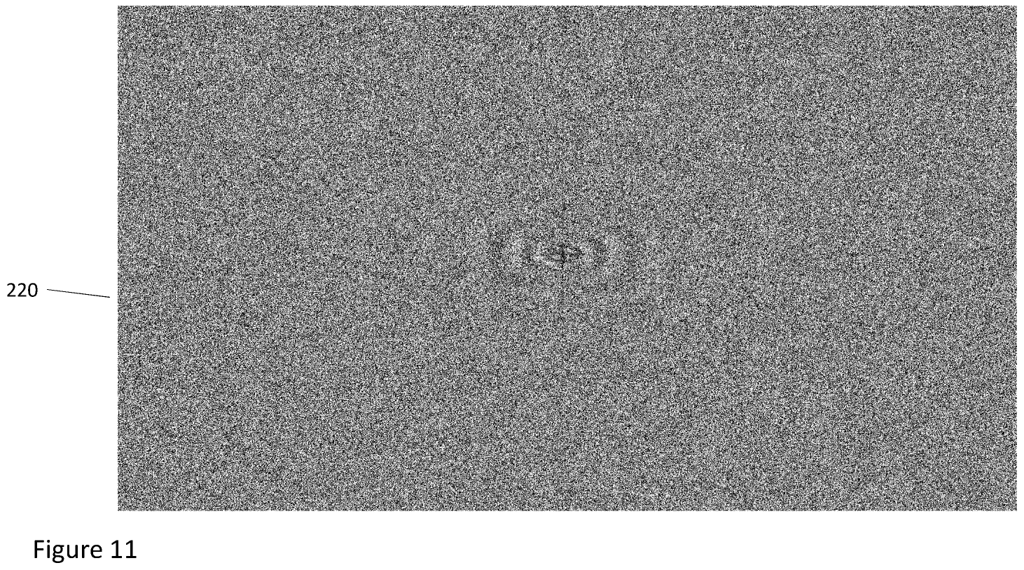

Because they are from a nearly stationary vantage point, altitude and optics, the images thus created have very similar frequency domain magnitude information with different phase information reflecting the motion of the waves. Waves in deep water move at approximately c≈1.25 \sqrt{λ}, where c is in meters per second and λ is in meters (varying slightly according to the local strength of g). The invention calculates this difference in phase by multiplying the Fourier transform of the first image by the complex conjugate of the Fourier transform of the second image (i.e., computing the cross-correlation). A sample cross-correlation for two images from the same vantage point separated in time is shown in FIG. 11. The plot 220 of FIG. 11 corresponds to two images taken from the video shown in FIG. 7.

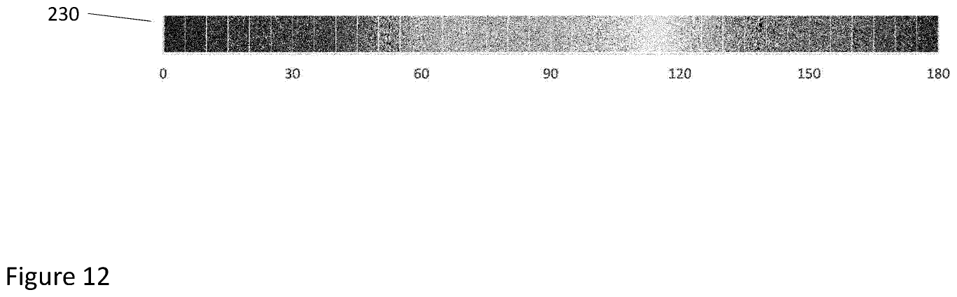

Referring to FIG. 11, the cross-spectrum phase plot 220 maps the phase angle through the color of each pixel. FIG. 12 shows the mapping of color to phase angle 230: red (which appears as a dark color at the right end of the mapping) represents a difference in phase of 180 degrees, blue (the dark color at the left end of the scale) represents zero. In the plot of FIG. 11, the outside edges of the image 220 correspond to the Nyquist frequency, with a wavelength of two pixels, or 0.1 m at this example's altitude and with these optics.

In this situation, the long wavelength waves (near the center of the cross-correlation phase plot 220) are moving toward the bottom-left corner of the image and the higher frequency waves are moving toward the left edge of the image (see traces of feature trackers 172 and 170 in FIG. 7). One can see this in FIG. 11 by looking closely at the red-blue/blue-red transitions.

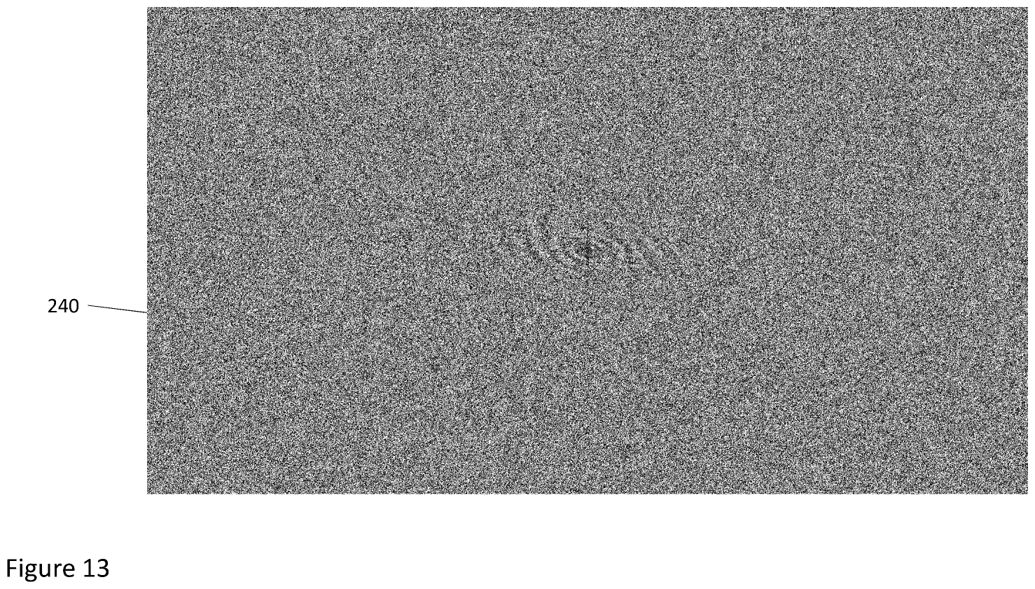

If the images are not taken from the same location, the phase shift is very different. For instance, FIG. 13 shows the phase change 240 for the same two images used in FIG. 11, before aligning them. In this case, the images are translated by 16 pixels vertically and 20 pixels horizontally relative to each other, which could have been caused by a 2.5-meter displacement of the camera laterally, a 2-degree shift in camera attitude, or some combination thereof.

The shift in phase due to a translation Δx in the camera position is additive to any other phase shift present in the images. Whereas wave-induced phase shift increases with the square root of frequency, displacement-induced phase shift is linear in frequency and proportional to the displacement. Thus, the total phase shift contribution Δϕ, due to these two effects over one second, is:

Δϕ=2π(fΔx+1.25\sqrt{f}) (1)

according to the deep-water approximation of wave celerity, where f represents the frequency.

In one embodiment, we precompute the theoretical Δϕ for zero translation using Equation (1) for reference to compute a cost function, which is then minimized to find the actual translation between the two images, as described in Section 2.1.

Solving for Horizontal Translation from Phase Information

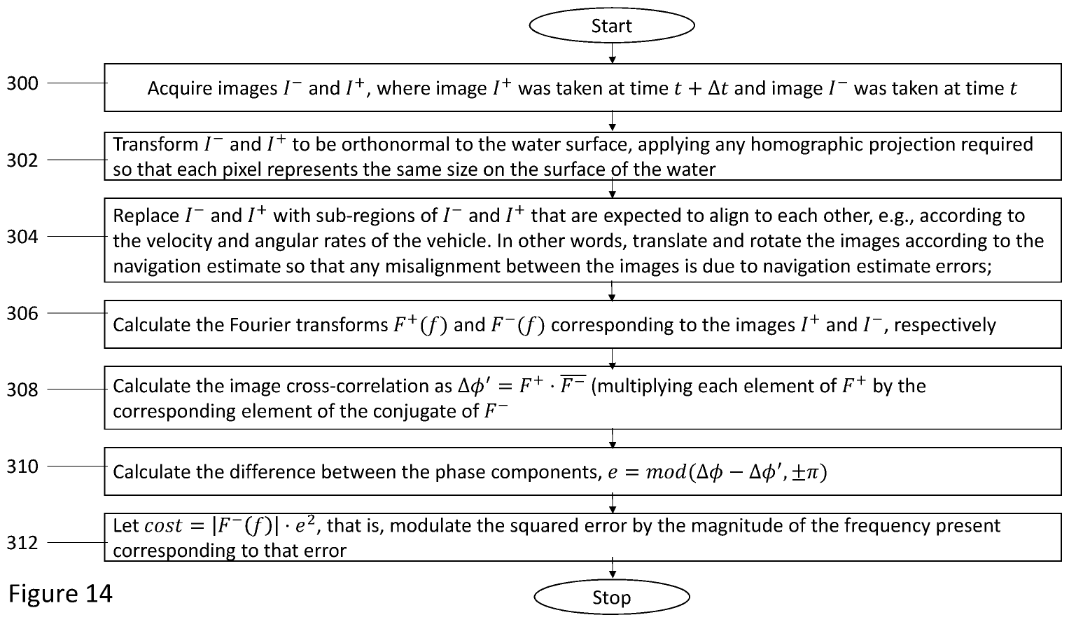

In practice, effects beyond displacement and wave motion also contribute to the phase change, resulting in the noise in FIG. 13. To permit an automated method to find the translation and rotation that aligns the time-separated images, we define a cost function measuring how well the observed cross-correlation's phase shift matches the theoretical phase shift from Equation (1). This proceeds according to the flow chart of FIG. 14:

Acquire images I⁻ and I⁺, where image I⁺ was taken at time t+Δt and image I⁻ was taken at time t

Transform I⁻ and I⁺ to be orthonormal to the water surface, applying any homographic projection required so that each pixel represents the same size on the surface of the water;

Replace I⁻ and I⁺ with sub-regions of I⁻ and I⁺ that are expected to align to each other, e.g., according to the velocity and angular rates of the vehicle. In other words, translate and rotate the images according to the navigation estimate so that any misalignment between the images is due to navigation estimate errors;

Calculate the Fourier transforms F⁺(f) and F⁻(f) corresponding to the images I⁺ and I⁻, respectively

Calculate the image cross-correlation as Δϕ′=F⁺·F̅⁻̅ (multiplying each element of F⁺ by the corresponding element of the conjugate of F⁻

Calculate the difference between the phase components, e=mod(Δϕ−Δϕ′,±π)

Let cost=|F⁻(f)|·e², that is, modulate the squared error by the magnitude of the frequency present corresponding to that error

To find the best fit, the frequency-based reference generator takes different sub-regions of I⁺, translated from the original by Δx, and repeats steps 306-312, employing gradient descent or a similar optimization method to find the Δx that minimizes cost. Once the Δx is found that minimizes cost, a second-order interpolation across cost values in the neighborhood of the minimum is used to find the translation Δx to fractions of a pixel. The resulting Δx is the output position measurement of the VRU.

Solving for Altitude from Phase Information

Error in altitude estimate changes the measurement of wavelength proportionally. The celerity of the waves, which can be measured by feature trackers or by observing the phase shift, is proportional to the square root of wavelength. Thus, we can solve for altitude by observing the wavelength angle and the speed of the waves or phase shift of the waves, again following the flowchart of FIG. 14 to calculate cost. Δx as used in Equation (1) to produce the Δϕ used in Step 310 of the flowchart of FIG. 14 is in terms of meters along the water's surface. Meters along the surface relate to image pixels linearly by a factor of the altitude, as adjusted by the camera calibration. The altitude that minimizes the cost function output in Step 312 is the best estimate for altitude. It is obvious that a similar optimization can be conducted to solve for altitude and translation simultaneously by including both variables in the gradient descent. Similarly, higher order nonlinear optimization methods may be used; for instance, Hessian of the cost function may be calculated to permit use of the conjugate gradient or newton methods.

### Solving for Water Depth

In water shallower than ½ the wavelength, celerity depends on water depth according to Equation 2:

$$C = \sqrt{\frac{g L}{2 π} tanh ( 2 π ( \frac{d}{L} ) )} \qquad ( 2 )$$

If position of the navigating platform is well estimated either by the methods presented here or via another method, the measurement of the water depth in shallow waters can be accomplished by comparing the observed phase changes in a series of Fourier-transformed images to the phase changes predicted by the decision variables representing the water depth, and finding the water depth values that minimize the discrepancy.

While the present invention has been illustrated by a description of various embodiments and while these embodiments have been described in some detail, it is not the intention of the inventors to restrict or in any way limit the scope of the appended claims to such detail. Thus, additional advantages and modifications will readily appear to those of ordinary skill in the art. The various features of the invention may be used alone or in any combination depending on the needs and preferences of the user.

What is claimed is:

1. A navigation system for a navigating platform, comprising:
a. a camera onboard said navigating platform, and
b. a processing unit configured to receive images from the camera, the processing unit programmed to calculate and output some or all elements of the platform's position, velocity and/or attitude states corrected for motion of the water.

2. The system of claim 1 further comprising an inertial measurement unit (IMU), and wherein output from the IMU is received by the system, and wherein the processing unit is cued by output from the IMU to provide an attitude state.

3. The system of claim 1 further comprising an altitude sensor coupled to the processing unit, the processing unit programmed to use the output of the altitude sensor in calculating elements of the platform's position, velocity and/or attitude states.

4. The system of claim 1 wherein the processing unit calculates the altitude state through a minimization in the frequency domain of a discrepancy between observed wave phase and predicted wave phase based on altitude.

5. The system of claim 1 wherein the processing unit performs a form of Lucas-Kanade optical flow tracking.

6. The system of claim 1 wherein the processing unit calculation minimizes error between a predicted phase shift and an observed phase predicted based on the relative motion between two images separated in time.

7. The system of claim 1 wherein the processing until performs a bundle adjustment optimization to solve for the positions and attitudes of the platform over time.

8. The system of claim 7 wherein the processing unit additionally solves for one or more of the following quantities:
a. velocity of one or more frequencies of waves;
b. wind velocity;
c. a relationship between the direction of travel of the platform and its orientation;
d. engine power;
e. airmass lift;
f. parameters of an equation describing distortion of the lens;

9. The system of claim 7 wherein the objective function weights are adjusted according to the degree of uncertainty in the measurements.

10. A vision system, comprising:
a. a camera, and
b. a processing unit configured to receive images from the camera, the processing unit programmed to calculate a shape and depth of a floor of the body of water in the camera's field of view by comparing a speed of propagation of waves observed by the camera to a speed of wave propagation predicted by a wave celerity equation.

11. A vision system, comprising:
a. a camera, and
b. a processing unit configured to receive images from the camera, the processing unit programmed to calculate a direction and/or speed of wind on water in different portions of the camera's field of view by calculating a magnitude and a direction of high frequency waves in the camera's field of view.
